(19) United States
(12) Patent Application Publication
(10) Pub. No.: US 2009/0312986 A1
(43) Pub. Date: Dec. 17, 2009

(54) Method and System for Determining Specified Data Related to Underground Installations

(75) Inventors: Mark A. Smith, Natrona Heights, PA (US); George L. Brandt, Bethel Park, PA (US); Christopher D. Carlin, Sewickley, PA (US)

Correspondence Address: THE WEBB LAW FIRM, P.C., 700 KOPPERS BUILDING, 436 SEVENTH AVENUE, PITTSBURGH, PA, 15219, US

(73) Assignee: GEOSPATIAL HOLDINGS, INC., Sarver, PA (US)

(21) Appl. No.: 12/484,586

(22) Filed: Jun. 15, 2009

Related U.S. Application Data
(60) Provisional application No. 61/061,314, filed on Jun. 13, 2008.

(51) Int. Cl. G06F 15/00; G06T 15/00

(52) U.S. Cl. 702/188; 345/419

(57) ABSTRACT

Provided is a system and method for analyzing a pipeline, that includes an analyzer mechanism, defined as a probe, configured to measure at least one physical characteristic associated with the pipeline and transmit data based upon the at least one measured physical characteristic. The invention includes at least one computer. The computer comprising programming instructions adapted to operate a processor to receive transmitted data from the probe; and programming instructions adapted to operate the processor to determine pipeline data associated with the pipeline. The invention can autonomously determine bending radius, pulling tension and sidewall pressure data. The physical characteristic data includes distance traveled depth, elevation, angle, changing in inclination, or change in speed.

### CROSS REFERENCE TO RELATED APPLICATIONS

This application is based on U.S. Provisional Patent Application No. 61/061,314, filed Jun. 13, 2008, on which priority of this patent application is based and which is hereby incorporated by reference in its entirety.

### BACKGROUND OF THE INVENTION

1. Field of the Invention

The present invention relates generally to methods, processes, and systems for determining data relating to underground installations and structures and, specifically, to a method and system for determining certain specified data points associated with underground conduit, piping, etc. In one embodiment, the present invention relates to an automated process for determining certain data points and variables including, but not limited to, pulling tension, sidewall pressure, clearance, and jamming factor for products installed into underground conduit and piping. The method and system of the present invention may utilize certain accurate, autonomous, and inertial-based mapping arrangements, e.g., a probe, computer programming logic, software code, and commercially-available computer aided drafting and design (CADD) software.

2. Description of the Related Art

Many industries and professions are faced with the challenge of safely and efficiently installing and/or delivering a product through the use of a conduit or pipe (a “pipeline”). In most cases, the physical characteristics of the pipeline, e.g., construction material, size, location, shape, length, and direction, are critical pieces of information that are necessary to ensure proper installation or delivery of the product within the pipeline. Once supplied with this data, end users, e.g., engineers, manufacturers, contractors, etc., utilize the information as inputs to certain formulae and calculations that are performed to establish the proper method of installation and/or delivery of the product within the limitations of the pipeline. Conversely, many types of pipeline products have their own limiting engineered specifications. Examples of these calculations and determinations include, but are not limited to: pipeline bending radius information; maximum pulling force tensions to be used when pulling cable or linings through a pipeline; sidewall pressure information to be used when pulling cable or linings through a pipeline; clearance and jamming factor information when pulling cable or linings through a pipeline; and a coefficient of friction information when pulling cable or linings through a pipeline.

According to the prior art, various methods are available and currently in use within the industry to capture and/or calculate this data. However, there is not a standardized approach to data accuracy or delivery methods. In addition, each method of data capture or calculation possesses some type of drawback or limitation. Examples of some of these limitations and drawbacks are as follows:

### Specification Documents and Engineering Design Drawings:

Pipelines are installed many times with no documentation of the physical location or actual “in-place” condition of the pipeline after installation. In these situations, end users are forced to perform calculations based on information provided by specification documents and engineering design drawings. Disadvantages to this approach lie in the fact that design specifications and engineering design drawings do not represent the actual in-place condition and location of the pipeline. As such, calculations performed with this type of data as input are not accurate and hold limited value to anyone who needs to install and/or deliver a product through the use of the pipeline.

### Remote Tracking Technologies:

Pipelines are installed many times via horizontal directional drilling (HDD) and/or jack-and-bore techniques. During these installations, the ability to determine the actual location is either not available or is not accurate, as based on current tracking technologies. In addition, these pipelines are installed at great depths, and visual confirmation and collection of coordinate-based locations of the pipeline is not possible. As such, the information detailing the location of the line from this method is inaccurate, and attempting to use data from this process can lead to potential issues when trying to determine the necessary information needed for these calculations.

Installation or “as-Built” Documentation:

Often, pipelines are installed where an effort has been made to document the physical location or actual in-place condition of the pipeline after installation. In these situations, pipeline installation personnel typically take measurements or perform industry standard land survey techniques to document the location and in-place condition of a pipeline at pre-determined intervals (such as talking a reading or measurement every fifty feet). Disadvantages to this approach are tied to the interval and method used to obtain the data readings, as data sets collected in this manner only represent visible characteristics (i.e., the outside) of a pipeline. Further, many times the data sampling interval is too large to provide the level of detail required to perform intricate calculations. In addition, the process of collecting data in this manner tends to be labor intensive and takes a substantial amount of time to complete. As such, information produced by this method, while being more reliable than data provided by specification documents and design drawings, is still inaccurate and holds limited value to anyone who needs to install and/or deliver a product through the use of the pipeline.

### Automation of Data Calculations:

Calculations necessary to establish the proper method of installation and/or delivery of the product within the limitations of a pipeline are tedious and somewhat time consuming to complete. There are currently software applications that have been written by various entities to help in this process, but most of the applications are not capable of taking physical location or actual in-place condition data and producing results in an automated manner. The lack of automation is typically a direct result of the limitations associated with the methods used in the capture data, with a great deal of user input and interpretation required to prepare the data for calculations. This poses a substantial drawback in the use of current software applications, as there is an increased chance for error every time there is user input and interpretation.

### Calculation of Data by Hand:

As stated above, calculations necessary to establish the proper method of installation and/or delivery of the product within the limitations of a pipeline are tedious and somewhat time consuming to complete. Limitations on existing software packages sometimes force end users to calculate, by hand, the proper method of installation and/or delivery of a product within a pipeline. This poses a substantial risk in relation to the accuracy of the calculated data and, again, there is an increased chance for error every time there is user input and interpretation. Another drawback to this approach is that the process of calculating data by hand is a slow, labor-intensive exercise.

### SUMMARY OF THE INVENTION

Therefore, it is an object of the present invention to provide a method and system for determining specified data related to underground installations that overcome some or all of the drawbacks and deficiencies noted above.

It is, therefore, an object of the present invention to provide a pipeline analyzing system that overcomes the drawbacks and deficiencies of the prior art in the field of installation and delivery through a pipeline. It is another object of the present invention to provide a pipeline analyzing system that provides pipeline survey data in an automated implementation. It is yet another object of the present invention to provide a pipeline analyzing system that provides an automated interface between a mapping probe and a computer analyzer having programming instructions for analyzing physical characteristic data.

Accordingly, provided is a system for analyzing a pipeline, that includes an analyzer mechanism configured to measure at least one physical characteristic associated with the pipeline and transmit data based upon the at least one measured physical characteristic. A computer having a computer readable medium having stored thereon instructions, which, when executed by a processor of the computer can cause the processor to implement the instructions, wherein the at least one computer is in communication with an input mechanism and a display unit, the computer comprising programming instructions adapted to operate the processor to receive the transmitted data; and programming instructions adapted to operate the processor to determine pipeline data associated with the pipeline. The bending radius data, pulling tension data, sidewall pressure data can be based at least in part upon the received data. The analyzer mechanism can be a probe including: internal data collection instrumentation configured to measure the at least one physical characteristic; and a storage device configured to store collected data. The physical characteristic can include distance traveled, depth, elevation, angle, change in inclination, or change in speed. The analyzer mechanism further comprises a communications interface to transmit the data to the at least one computer. The programming instructions are adapted to operate the processor to convert the data received from the at least one analyzer mechanism into a readable format. The received data can include physical characteristic data in three dimensions for at least one specified point along the pipeline. The computer also includes programming instructions adapted to operate the processor to generate a three-dimensional array of X-Y-Z data representative of physical characteristics of the pipeline, wherein the three-dimensional array is parsed into individual three-dimensional points comprising x, y, and z numeric values; and condense the three-dimensional array into a condensed three-dimensional array comprising a point array including specified points from the three-dimensional array, until the point array is of a specified size for processing.

Further, the pipeline analyzing system includes programming instructions adapted to operate the processor to determine a straight three-dimensional line drawn from a starting point to an ending point; loop through the three-dimensional array, extracting three-dimensional coordinates; and insert the extracted three-dimensional coordinates as nodes into the straight three-dimensional line until all the three-dimensional coordinates have been inserted, thereby forming a segmented three-dimensional line representing a pipeline centerline, analyze the three-dimensional array and indicate station marks along a straight three-dimensional line; analyze the three-dimensional array and visually indicate a profile view of the pipeline on the display unit; convert the profile view into segments and arcs; combine station marks and the profile view into one three-dimensional line; calculate pulling tension data; calculate sidewall pressure; create at least one engineering drawing; or any combination thereof.

Still further, the pipeline analyzing system includes programming instructions adapted to operate the processor to calculate pulling tension data by: examining a first segment of a segmented three-dimensional line; determining a type of segment; determining, based on the type of segment, a category of segment; applying a pulling tension equation; storing the result of the application for the segment in a variable; utilizing the variable as tension in connection with a subsequent segment; and repeating for each segment of the segmented three-dimensional line. The segment categories include at least one of the following: a horizontal line, an inclined line, a horizontal arc, a concave up arc, a concave down arc, or any combination thereof.

Further provided is a computer-implemented method on at least one computer having a computer readable medium having stored thereon instructions, which when executed by a processor of the computer, causes the processor to implement the method. The method includes: receiving data transmitted from at least one analyzer mechanism configured to measure at least one physical characteristic associated with a pipeline; and determining pipeline data associated with the pipeline. The method further includes programming instructions adapted to operate the processor to determine, based at least in part upon the received data, at least one of the following: bending radius data; pulling tension data; sidewall pressure data; or any combination thereof. The physical characteristic can include at least one of the following: distance traveled; depth; elevation; angle; change in inclination; change in speed; or any combination thereof. The method further includes one interface to receive the data transmitted from the at least one analyzer mechanism in at least one of the following forms: wirelessly; hard-wired; via a portable memory device; or any combination thereof. The method further includes programming instructions adapted to operate the processor to generate a three-dimensional array of X-Y-Z data representative of physical characteristics of the pipeline, wherein the three-dimensional array is parsed into individual three-dimensional points comprising x, y, and z numeric values. The method further includes programming instructions adapted to operate the processor to condense the three-dimensional array into a condensed three-dimensional array comprising a point array including specified points from the three-dimensional array, until the point array is of a specified size for processing. The method further includes programming instructions adapted to operate the processor to: determine a straight three-dimensional line drawn from a starting point to an ending point; loop through the three-dimensional array, extracting three-dimensional coordinates; and insert the extracted three-dimensional coordinates as nodes into the straight three-dimensional line until all the three-dimensional coordinates have been inserted, thereby forming a segmented three-dimensional line representing a pipeline centerline.

Still, further provided is an article comprising a machine-readable storage medium containing instructions that, if executed, enable a processor to receive data transmitted from at least one analyzer mechanism configured to measure at least one physical characteristic associated with a pipeline; and determine pipeline data associated with the pipeline.

Still, further provided is a pipeline analyzing software stored on a storage medium to analyze a pipeline, the software comprising programming instructions that, if executed, enable a processor to receive data transmitted from at least one analyzer mechanism configured to measure at least one physical characteristic associated with a pipeline; and determine pipeline data associated with the pipeline.

Still, further provided is a method for determining pipeline data for installing a product in a pipeline, comprising: measuring, by at least one analyzer mechanism, at least one physical characteristic of a pipeline, thereby creating measurement data; transmitting, from the at least one analyzer mechanism, at least a portion of the measurement data; and receiving the transmitted measurement data on at least one computer and determining at least one of pulling tension data and bending radius data, based at least in part on the received measurement data. The method further includes: placing at least one probe into the pipeline; moving the probe through the pipeline; measuring the at least one physical characteristic using internal data collection instrumentation of the probe; and storing the measured at least one physical characteristic on a storage device of the probe.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

These and other features and characteristics of the present invention, as well as the methods of operation and functions of the related elements of structures and the combination of parts and economies of manufacture, will become more apparent upon consideration of the following description. As used in the specification, the singular form of “a”, “an”, and “the” include plural referents unless the context clearly dictates otherwise.

### BRIEF DESCRIPTION OF THE DRAWING(S)

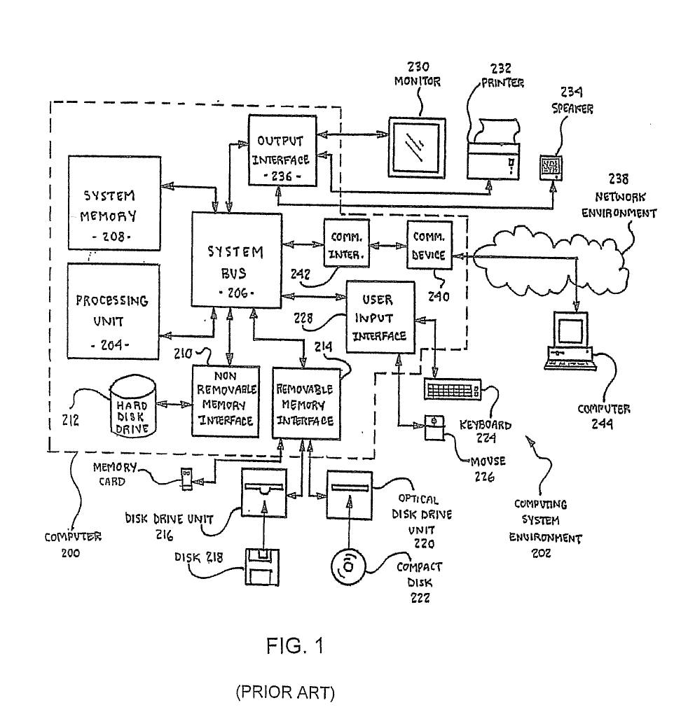

FIG. 1 is a block diagram illustrating an exemplary system for a pipeline analyzer system;

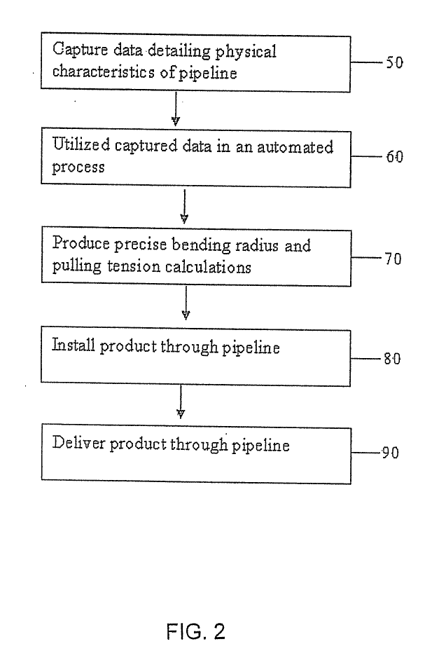

FIG. 2 is a flow chart illustrating a method of analyzing a pipeline;

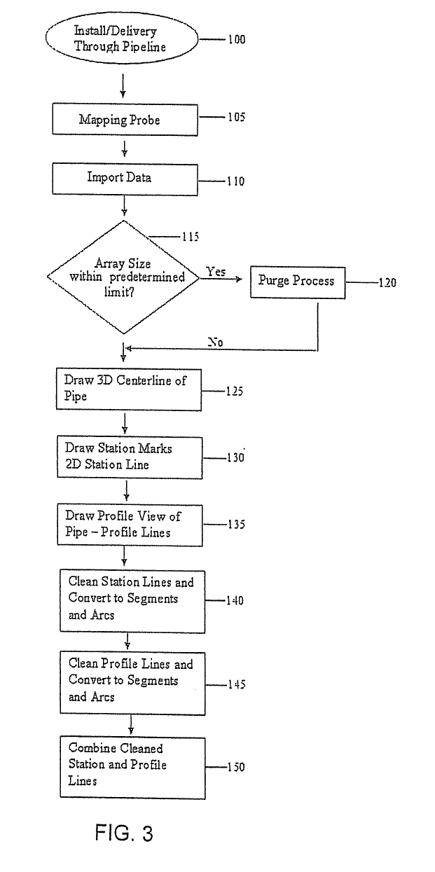

FIG. 3 is a flowchart illustrating a method of analyzing physical characteristic data;

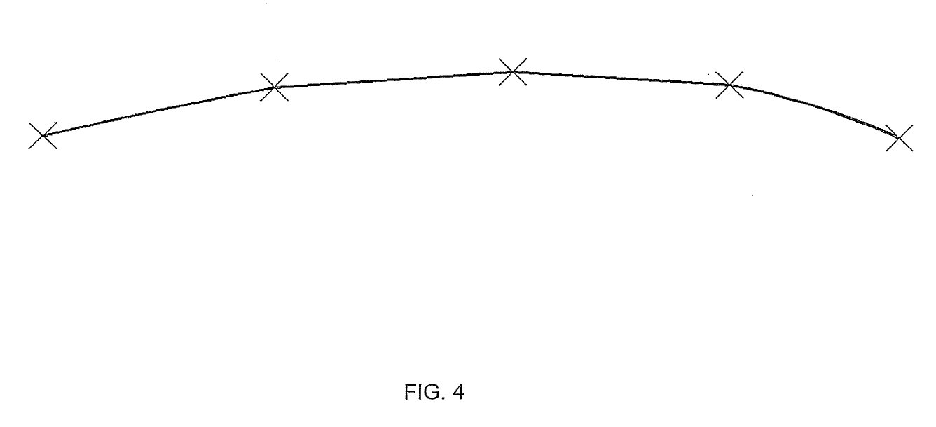

FIG. 4 is a plan view of a three-dimensional line with nodes;

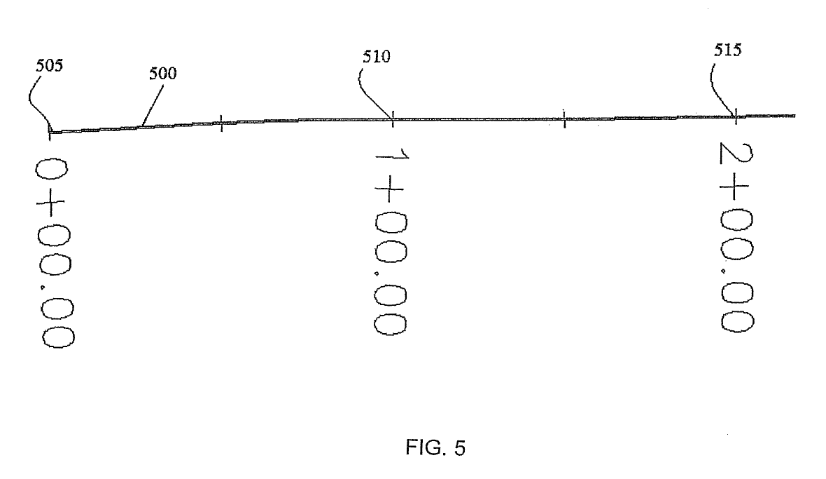

FIG. 5 is a side view of a two-dimensional line with station marks;

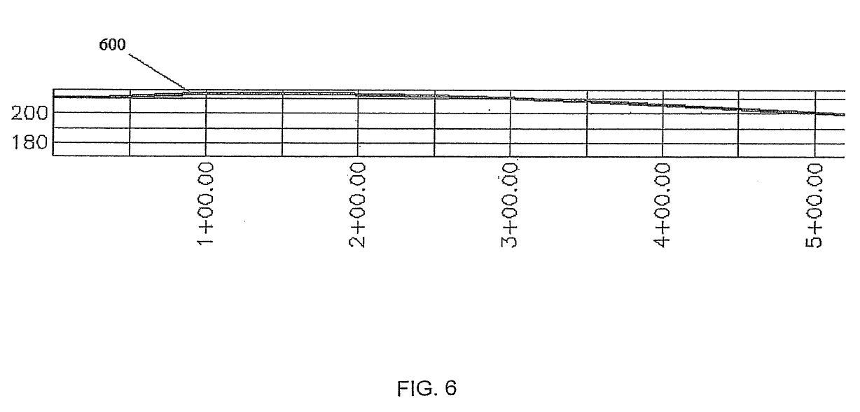

FIG. 6 is a profile view of a pipeline with elevation;

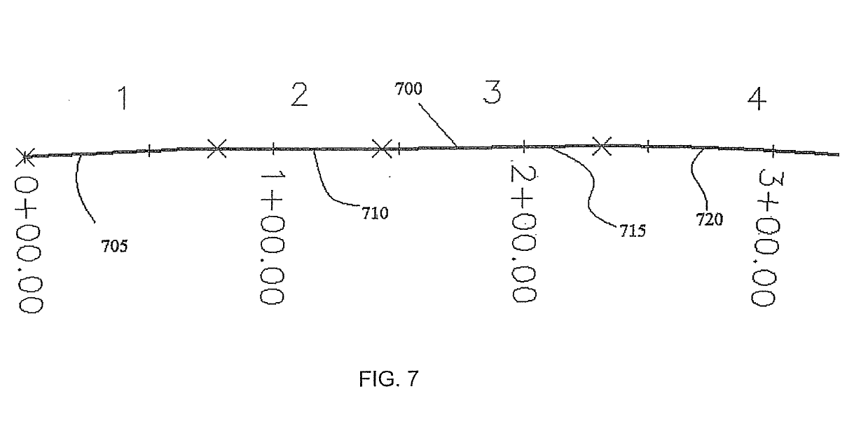

FIG. 7 is a view of a station line converted to arcs and segments;

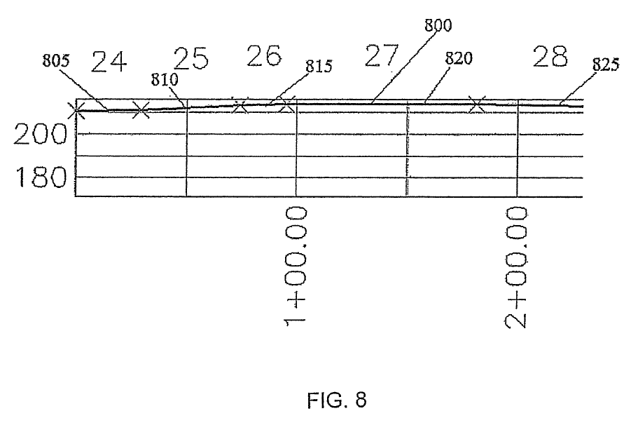

FIG. 8 is a profile view converted to arcs and segments;

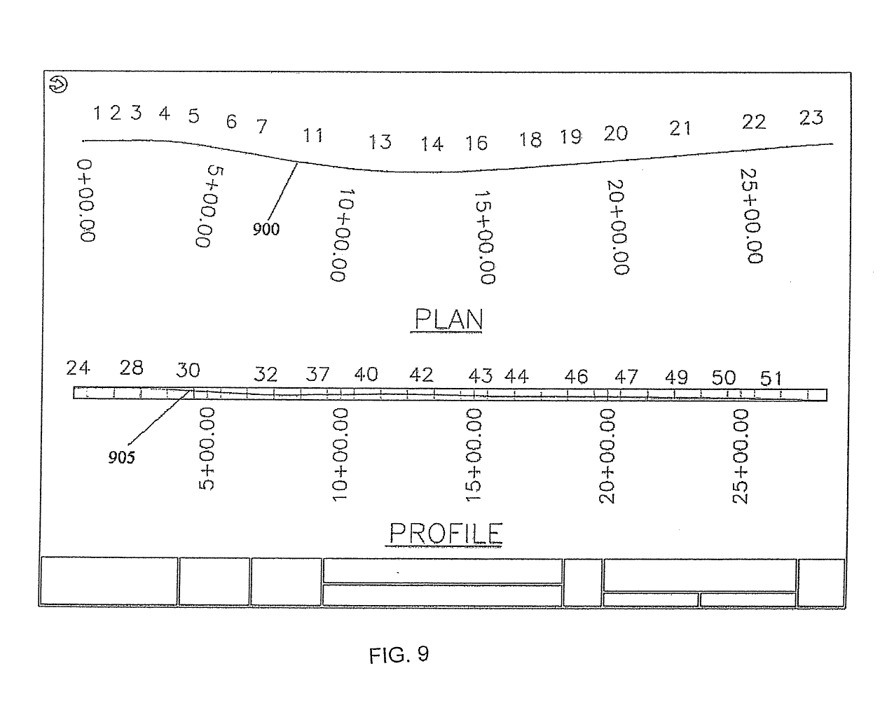

FIG. 9 is a computer generated view showing a plan view with station marks and a profile view with elevation; and

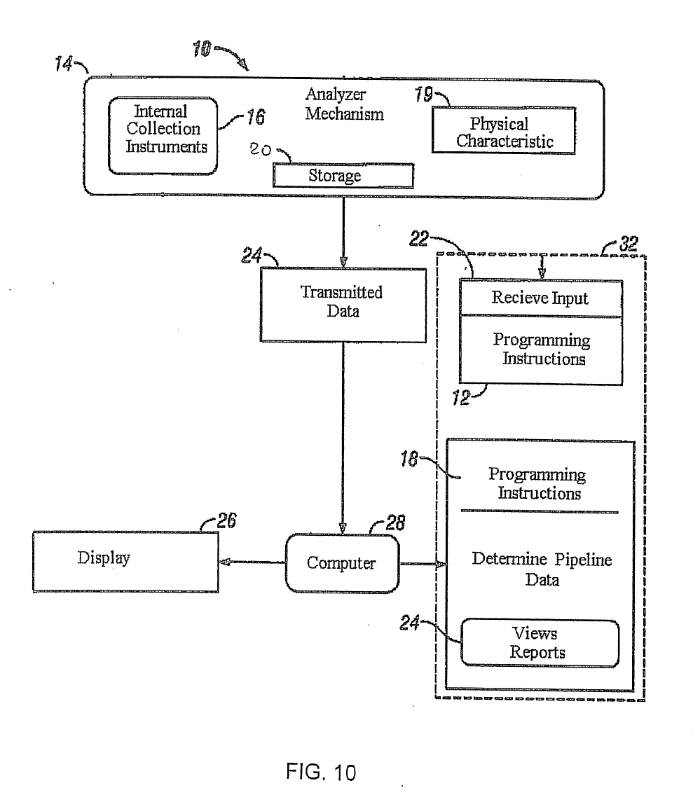

FIG. 10 is a block diagram illustrating an exemplary system for analyzing a pipeline and creating pipeline data.

### DETAILED DESCRIPTION OF THE PREFERRED EMBODIMENT(S)

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

The present invention may be implemented on a variety of computing devices and systems, wherein these computing devices include the appropriate processing mechanisms and computer-readable media for storing and executing computer-readable instructions, such as programming instructions, code and the like. As illustrated in FIG. 1 and according to the prior art, a schematic and block diagram of exemplary computing devices, in the form of personal computers 200, 244, in a computing system environment 202 are provided. This computing system environment 202 may include, but is not limited to, at least one computer 200 having certain components for appropriate operation, execution of code, and creation and communication of data. For example, the computer 200 includes a processing unit 204 (typically referred to as a central processing unit or CPU) that serves to execute computer-based instructions received in the appropriate data form and format. Further, this processing unit 204 may be in the form of multiple processors executing code in series, in parallel or in any other manner for appropriate implementation of the computer-based instructions.

In order to facilitate appropriate data communication and processing information between the various components of the computer 200, a system bus 206 is utilized. The system bus 206 may be any of several types of bus structures, including a memory bus or memory controller, a peripheral bus, or a local bus using any of a variety of bus architectures. In particular, the system bus 206 facilitates data and information communication between the various components (whether internal or external to the computer 200) through a variety of interfaces, as discussed hereinafter.

The computer 200 may include a variety of discrete computer-readable media components. For example, this computer-readable media may include any media that can be accessed by the computer 200, such as volatile media, non-volatile media, removable media, non-removable media, etc. As a further example, this computer-readable media may include computer storage media, such as media implemented in any method or technology for storage of information such as computer-readable instructions, data structures, program modules, or other data, random access memory (RAM), read only memory (ROM), electrically erasable programmable read only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computer 200. Further, this computer-readable media may include communications media, such as computer-readable instructions, data structures, program modules, or other data in a modulated data signal such as a carrier wave or other transport mechanism and include any information delivery media, wired media (such as a wired network and a direct-wired connection), and wireless media (such as acoustic signals, radio frequency signals, optical signals, infrared signals, biometric signals, bar code signals, etc.). Of course, combinations of any of the above should also be included within the scope of computer-readable media.

The computer 200 further includes a system memory 208 with computer storage media in the form of volatile and non-volatile memory, such as ROM and RAM. A basic input/output system (BIOS) with appropriate computer-based routines assists in transferring information between components within the computer 200 and is normally stored in ROM. The RAM portion of the system memory 208 typically contains data and program modules that are immediately accessible to or presently being operated on by processing unit 204, e.g., an operating system, application programming interfaces, application programs, program modules, program data and other instruction-based computer-readable code.

The computer 200 may also include other removable or non-removable, volatile or nonvolatile computer storage media products. For example, the computer 200 may include a non-removable memory interface 210 that communicates with and controls a hard disk drive 212, i.e., a non-removable, non-volatile magnetic medium; and a removable, non-volatile memory interface 214 that communicates with and controls a magnetic disk drive unit 216 (which reads from and writes to a removable, non-volatile magnetic disk 218), an optical disk drive unit 220 (which reads from and writes to a removable, non-volatile optical disk, such as a CD ROM), a Universal Serial Bus (USB) port for use in connection with a removable memory card 222, etc. However, it is envisioned that other removable or non-removable, volatile or non-volatile computer storage media can be used in the exemplary computing system environment 200, including, but not limited to, magnetic tape cassettes, DVDs, digital video tape, solid state RAM, solid state ROM, etc. These various removable or non-removable, volatile or non-volatile magnetic media are in communication with the processing unit 204 and other components of the computer 200 via the system bus 206. The drives and their associated computer storage media discussed above and illustrated in FIG. 1 provide storage of operating systems, computer-readable instructions, application programs, data structures, program modules, program data and other instruction-based computer-readable code for the computer 200 (whether duplicative or not of this information and data in the system memory 208).

A user may enter commands, information and data into the computer 200 through certain attachable or operable input devices, such as a keyboard 224, a mouse 226, etc., via a user input interface 228. Of course, a variety of such input devices may be utilized, e.g., a microphone, a trackball, a joystick, a touchpad, a touch-screen, a scanner, etc., including any arrangement that facilitates the input of data and information to the computer 200 from an outside source. As discussed, these and other input devices are often connected to the processing unit 204 through the user input interface 228 coupled to the system bus 206, but may be connected by other interface and bus structures, such as a parallel port, game port, or a universal serial bus (USB). Still further, data and information can be presented or provided to a user in an intelligible form or format through certain output devices, such as a monitor 230 (to visually display this information and data in electronic form), a printer 232 (to physically display this information and data in print form), a speaker 234 (to audibly present this information and data in audible form), etc. All of these devices are in communication with the computer 200 through an output interface 236 coupled to the system bus 206. It is envisioned that any such peripheral output devices be used to provide information and data to the user.

The computer 200 may operate in a network environment 238 through the use of a communications device 240, which is integral to the computer or remote therefrom. This communications device 240 is operable by and in communication to the other components of the computer 200 through a communications interface 242. Using such an arrangement, the computer 200 may connect with or otherwise communicate with one or more remote computers, such as a remote computer 244, which may be a personal computer, a server, a router, a network personal computer, a peer device, or other common network node, and typically includes many or all of the components described above in connection with the computer 200. Using appropriate communications devices 240, e.g., a modem, a network interface or adapter, etc., the computer 200 may operate within and communication through a local area network (LAN) and a wide area network (WAN), but may also include other networks such as a virtual private network (VPN), an office network, an enterprise network, an intranet, the Internet, etc. It will be appreciated that the network connections shown are exemplary and other means of establishing a communications link between the computers 200, 244 may be used.

As used herein, the computer 200 includes or is operable to execute appropriate custom-designed or conventional software to perform and implement the processing steps of the method and system of the present invention, thereby forming a specialized and particular computing system. Accordingly, the presently-invented method and system may include one or more computers 200 or similar computing devices having a computer-readable storage medium capable of storing computer-readable program code or instructions that cause the processing unit 202 to execute, configure or otherwise implement the methods, processes and transformational data manipulations discussed hereinafter in connection with the present invention. Still further, the computer 200 may be in the form of a personal computer, a personal digital assistant, a portable computer, a laptop, a palmtop, a mobile device, a mobile telephone, a server, or any other type of computing device having the necessary processing hardware to appropriately process data to effectively implement the presently-invented computer-implemented method and system.

With reference to FIG. 2, a pipeline analyzing system is described accordingly, the present invention is directed to a method and system for determining specified data related to underground installations, e.g., underground conduit and pipelines. In step 50, the system captures accurate data detailing the physical characteristics of a pipeline. In step 60, the system utilizes the captured data in an automated process. In step 70, the system produces precise bending radius and pulling tension calculations that can be used in a variety of reporting tools to determine the layout and constraints for existing pipeline. In step 80, installation of a product proceeds through the pipeline. In step 90, delivery of a product proceeds through the pipeline. The system can utilize an accurate, autonomous, inertial-based mapping probe, computer programming logic, software code and commercially-available CADD software to produce pulling tension, sidewall pressure, clearance calculations, jamming factor calculations, and coefficients of friction. It is an object of the invention to utilize an autonomous, inertial-based mapping probe to gather location and in-place condition data for a pipeline that produces rapid accurate results; data values can be gathered at up to one-inch intervals with the mapping probe. Data sets produced by the mapping probe may be directly input into the software application with no need for human interpretation. Calculations produced by the presently-invented method and system are completely automated. Calculations produced by the presently-invented software application are completely automated, producing results that are extremely accurate by removing the chance for human error. In a preferred embodiment, the process utilizes an accurate, autonomous, inertial-based mapping probe, computer programming logic, software code and commercially-available CADD software to produce pulling tension, sidewall pressure, clearance calculations, jamming factor calculations, and coefficients of friction.

An analyzing mechanism defined as a mapping probe can be inserted into one end of an open pipe and travel to the other open end. It can be manually or mechanically pulled via a rope, cable, or line through the pipe. It can also be pushed through the pipe via air, fluid, or robotic propulsion. The probe will contain internal data collection instruments that measure the distance traveled, depth, elevation, angle, change in inclination, and speed of the probe. It will contain internal storage devices that store the information collected allowing the probe to travel un-tethered through the pipe. The probe can also include communication devices to transfer, wirelessly, data it receives either immediately, at a programmed time, or at a set interval while traveling through the pipeline. The probe technology comprises an array of data collection instruments which include accelerometers, gyroscopes, and odometers located within each of the probe bodies. As the smart probe moves through the pipeline it can record all changes in inclination, heading and velocity at a rate of 800 times per second. This information is stored on a hard drive within the probe.

In the preferred embodiment, the probe is autonomous and not tethered via a data cable to the surface and does not communicate with the surface at all. The probe is not restricted by the depth of ground cover over the pipeline nor is it subject to possible interference derived from other pipeline or metals located within the soil. There is no requirement to “trace” the movement of the probe from above ground. The smart probe is provided with its starting coordinates and its ending coordinates, and the internal data collection instruments along with the software record everywhere that the probe travels between those known coordinates.

Depending on the pipeline interior surface and condition, various wheel-sets with protruding carrier legs are used to assure the positioning of the probe body within the pipe. The ability to economically design and develop multiple specifications for the smart probe bodies or carriers and utilize the same instrumentation modules is a key element to the smart probe technology. Modifying the probe bodies allows operations in high pressure, high temperature, and many caustic environments. The basic Smart Probe is designed for use within a non-pressurized pipeline environment. Smart probes have been designed and are in use in pressurized environments up to 6.55 bar (95 psi). The probes can be capable of operating in environments up to 241 bar (3500 psi) with battery and memory capacities allowing for very long distance runs. The probe can have over thirty instruments to collect approximately 800 accurate readings per second as the probe moves within the pipeline. This physical characteristic data is saved on a hard drive within the Smart Probe and then transmitted at the end of the run to a computer. The physical characteristic data collection method type is not meant to be a limiting feature of the invention as one skilled in the art may envision other known techniques to measure the physical characteristics of the pipeline.

After surveying the pipeline, the probe is removed from the end of the pipeline, the probe can communicate with a physical characteristics analyzer, a computer, or other data holding device having programming instructions to perform calculations, an example of such a computer device 200 is described hereinabove with reference to FIG. 1. The physical characteristic data is then transmitted by the probe to a computer device 200 where it can be processed or stored in memory on the computer device 200. The transmission can occur via USB or other wired communication techniques or also using wireless or memory storage cards and disks. Programming instructions on the computer device will operate a processor to process the transmitted data from all the instruments in the probe and will process and convert the data into a readable format describing the probe's exact location in three dimensions, i.e., X-Y-Z data, at any given point along the pipe as follows:
763594.870000, 2877717.700000, 210.470000
763594.413419, 2877719.926949, 210.463260
763594.413419, 2877719.926949, 210.463260
763594.265899, 2877720.646380, 210.460034
763594.064304, 2877721.629357, 210.455267
763593.863577, 2877722.606496, 210.451348
763593.660874, 2877723.592634, 210.448455

With reference to FIG. 4, a system and method of analyzing a pipeline is shown. In step 100, Computer Program Initial Setup occurs on a mapping probe and a computer device 200, shown in FIG. 1. In step 105 of FIG. 4, a mapping probe can be utilized to survey the pipeline. In step 110, the import data can be transferred from the probe into the pipeline analyzer system. In step 115, a determination can be made as to the condition of the data for import processing on the analyzer system. If the data array exceeds a size for effective processing, at step 120, purge and order of the point array occurs. If the data array is sufficient, based on the processing capabilities of the analyzer system, for effective processing, processing of the data occurs in the next steps. In step 125, the analyzer system produces a drawing of a three-dimensional centerline of pipe. In step 130, the analyzer system produces a drawing of a station marks line. In step 135, the analyzer system produces a drawing of a Profile View of Pipe. In step 140, programming instructions of the system clean Station Lines and Convert the station lines to Segments and Arcs. In step 140, programming instructions of the system clean profile lines and convert to segments and arcs. In step 145, programming instructions of the system combine cleaned station and profile lines into one three-dimensional line.

After the calculation methods are completed, the system can process the data sets produced to determine pulling tension values, maximum tension on cable conductors, sidewall pressure, and engineering drawings.

In step 100 of FIG. 4, the system, in conjunction with a commercially available CADD package or other GIS/sketching/drawing software, will be started on a computer device as shown in FIG. 1, containing the X-Y-Z data or on another computer device at a remote location, the location of the computer device is non-limiting and multiple computer devices can be utilized in addition to different architectures such as tiered or client server. A database, not shown, can be used to hold the data and can be queried through known query methods to access the data. Programming instructions present on the computer device can run a setup procedure that assigns starting values to variables. They can also define links to outside information such as drawing title blocks, north arrows, scale bars, images, data connections, text sizes, text styles, and other information needed during the process.

After the setup procedure is finished and the probe has transmitted the data to the computer device of the system, the system will import the readable X-Y-Z data into computer memory (step 110) and create pipeline data. The system will extract each line of X-Y-Z data from the imported file. The system will parse it into its individual x, y, and z numeric values (three-dimensional points). The system will store each three-dimensional point in a three-dimensional point list or array as follows:

((763594.870000, 2877717.700000, 210.470000) (763594.413419,
2877719.926949, 210.463260) (763594.413419, 2877719.926949,
210.463260) (763594.265899, 2877720.646380, 210.460034)
(763594.064304, 2877721.629357, 210.455267) (763593.863577,
2877722.606496, 210.451348) (763593.660874, 2877723.592634,
210.448455))

Next, the system can determine if the three-dimensional point array is too large (step 115). If the three-dimensional point array is too large for the computer software or computer device to handle, the three-dimensional point array can be purged. This step is not required for the invention to work, but can be used to minimize the processing time and bandwidth requirements in the event the three-dimensional point array is transferred to a second computer device for processing. The size condition is determined by comparing the size of the array to a predetermined size limit that can be automatically generated, user generated, or hard coded into the pipeline analyzer system. If the size of the point array is too large, a new point array will be created and populated with every other point from the original array (purged). The purging process will continue until the point array is of adequate size for processing. After the point array is purged, the pipeline analyzer system will determine if the point array is to be processed from the first point collected to the last point collected or from the last point to the first point by reading the desired direction from outside user input or automatically generated input. If it is determined that the array will be processed from the last point to the first point, the pipeline analyzer system will reverse the order of the array and store the new array.

With reference to FIG. 4, the pipeline analyzing system creates a three-dimensional line that represents the centerline of the pipe using point data from the three-dimensional point array (step 125). The length of the array, the starting point, and the ending point will be read from the point array and stored in computer memory of computer device 200. The analyzing system includes programming instructions to generate coordinates representing the corners of a view window. The analyzing system uses the southwestern and northeastern most x and y values from the starting and ending points of the three-dimensional point array and combines them into three-dimensional points. The pipeline analyzer system can display the windowed area on the computer screen. A CADD or GIS package can be used to implement the display. Initially, a straight, three-dimensional line will be drawn from the starting point to the ending point. The analyzing system will then loop through the three-dimensional point array, extracting three-dimensional coordinates, and inserting them as new nodes into the straight three-dimensional line until all the coordinates have been inserted. As illustrated in FIG. 4, the end result will be a multi-segmented three-dimensional line drawn to exact, collected three-dimensional coordinates representing the pipe centerline. X markings on the line of FIG. 4 indicate spacing a foot apart.

With reference to FIG. 5, the pipeline analyzing system can draw a two-dimensional line 500 with station markings 505, 510, and 515 to accurately depict the pipe centerline in the horizontal plane (step 130). Programming instructions can extract each point from the three-dimensional array and parse it into its individual x and y numeric values (two-dimensional points). The two-dimensional points are stored in a two-dimensional point list or array. The pipeline analyzer system will loop through the two-dimensional array, extract two-dimensional points, and draw two-dimensional lines between the points until all the points have been extracted. The pipeline analyzer system will also place a perpendicular tick mark representing a station every 10 feet or other measured unit. As shown in FIG. 5, the stations 505, 510, and 515 are 10 feet apart, therefore, there is a starting station and two additional stations, with the last station 515, 2+00.00, located 20 feet from the initial starting point. It will start at the beginning of the two-dimensional line and calculate the distance from the first two-dimensional point to the second two-dimensional point. If the distance is less than 10, it will calculate the distance between the second and third points and add this value to the distance between the first and second points, and check to see if the total distance from the first point to the third point is greater than 10. This process will continue all the way down the two-dimensional line, placing a station mark at every 10-foot interval. The pipeline analyzer system will also label the station mark with text as shown in FIG. 5.

With reference to FIG. 6, the pipeline analyzing system can draw a profile or side view of the pipe 600 showing the change in elevation on a grid. The system is programmed to read the first and second points from the three-dimensional point array and store them in individual variables. The pipeline analyzer system can calculate the horizontal distance and change in elevation between the two three-dimensional points and create new points for drawing the profile line. The system can also multiply the change in elevation by a vertical scale factor, which can be supplied by a user, automatically generated, or hard coded into the pipeline analyzer system in order to extrapolate the graph. These new profile points can be stored in a profile point array. The pipeline analyzer system will loop through the three-dimensional point array and generate a new profile point, as described above, for each three-dimensional point and store the new point in the profile point array. As seen in FIG. 6, after the profile point array is completed, the pipeline analyzer system will loop through the profile point array, read each point, and draw a profile line between the points until all the points have been read. The graph shows that the pipe is at its highest around approximately 150 ft. at an elevation of approximately 205 ft. The pipe slopes downward from its highest point to the 500 ft. mark.

With reference to FIG. 7, the pipeline analyzer system cleans the two-dimensional station line and the profile lines (steps 140 and 145). A segment and arc tolerance is inputted to memory. The segment and arc tolerance is a perpendicular distance that a node can be from the segment or arc that runs through the nodes before and after it and still be considered part of that segment or arc. The segment and arc tolerance can also be hard coded into the system. The system will then analyze the second node of the two-dimensional line and compare it to the first and third nodes. If the second node is within the segment tolerance, the pipeline analyzer system will draw a straight line between the first and third nodes and consider that new line a segment. The pipeline analyzer system then analyzes the third node and compares it to the nodes directly before and after it, i.e., the second and fourth nodes. If the third node also falls within the segment tolerance, it, too, can be added to the segment, as long as the new segment does not cause any of the previously-examined nodes to fall outside the tolerance. This process can continue until one of the examined nodes falls outside of the segment tolerance. When a node is outside the tolerance, the pipeline analyzer system will jump to the next node and examine it to determine if it should start a new segment or arc. If it falls within the segment tolerance of the nodes before and after it, it will start to draw a new line segment. If it falls outside of the segment tolerance, the angles formed between the three points will be compared and if similar, a new arc will be started.

After this process is completed on both the two-dimensional station and profile lines, the segments and arcs can be labeled and their attributes can be stored, exported, and/or displayed. This pipeline data includes length, type, radius, coordinates, and angle. As illustrated in the tables below, the conversion to segments and arcs has created 7 different arcs and segments (horizontal plane curve data) from the two-dimensional line segment and 5 lines (vertical plane curve data) from the profile line.

HORIZONTAL PLANE CURVE DATA

| | | HORIZ | ARC | | | BEGINNING |
|---|---|---|---|---|---|---|
| SEG | TYPE | LENGTH | LENGTH | BEARING | RADIUS | STATION |
| 1 | ARC | | 77.0744′ | | 1892.7781′ | 0 + 00.00 |
| 2 | LINE | 66.0876′ | | 98.5230′ | | 0 + 77.07 |
| 3 | LINE | 88.1115′ | | 99.2135′ | | 1 + 43.16 |
| 4 | ARC | | 124.1032′ | | 1400.8257′ | 2 + 31.27 |
| 5 | ARC | | 98.0042′ | | 1303.4058′ | 3 + 55.38 |
| 6 | LINE | 187.9939′ | | 88.9973′ | | 4 + 53.38 |
| 7 | LINE | 44.0027′ | | 88.5016′ | | 6 + 41.37 |

VERTICAL PLANE CURVE DATA

| | | | | | | BEGIN- |
|---|---|---|---|---|---|---|
| | | | ARC | | RA- | NING |
| SEG | TYPE | LENGTH | LENGTH | ANGLE | DIUS | STATION |
| 24 | LINE | 29.0575′ | | 0.6509′ | [symbol] | 0 + 00.00 |
| 25 | LINE | 45.0500′ | | 2.8775′ | | 0 + 29.06 |
| 26 | LINE | 21.0541′ | | 1.3286′ | | 0 + 74.05 |
| 27 | LINE | 86.1133′ | | 0.0837′ | | 0 + 95.10 |
| 28 | LINE | 66.1004′ | | −1.1309′ | | 1 + 81.21 |

With continuing reference to FIG. 7, line 700 is a partial two-dimensional line converted to arcs and segments and having the characteristics of the horizontal plane data shown above. As shown, the line 700 has an arc 705 starting from 0 ft. extending to 77.07 ft. Next, is a line 710, from the ending of arc 705 starting at 77.07 ft., extending approximately 66 ft. to approximately 143.16 ft. As can be seen, the arc 705 and the line 710 are made up of multiple measured points combined by the pipeline analyzer system into respective arcs and segments, since each point in this example was initially spaced a foot apart, the system has combined approximately 77 points to form arc 705. Similarly, line 715 and arc 720 are formed.

With reference to FIG. 8, line 800 is a partial profile line converted to arcs and segments and having the characteristics of the vertical plane data shown above. As shown, the line 800 has a line 805 from 0 ft. to 29.06 ft. Next, is a line 810, from the ending of line 805 at 29.06 ft., extending approximately 45 ft. to approximately 74.05 ft. As can be seen, the line 805 and the line 810 are made up of a number of points combined by the pipeline analyzer system into arcs and segments, since each point in this example was a foot apart; the system has combined approximately 29 points to form line 805. Lines 815, 820, and 825 are similarly formed.

The pipeline analyzer system can combine the cleaned station and profile lines into one three-dimensional line and a segment array (step 150 of FIG. 3). The line segments and arcs that make up the station and profile lines begin and end at different locations, overlapping in most cases because the lines and arcs formed for each have different lengths as one is on the vertical plane and one is on the horizontal plane and have different shapes therein. The analyzer system can combine the arcs and segments from the two lines and create a third, cleaned three-dimensional line, which can be used to calculate pulling tension, sidewall pressure, clearance and jamming factor. Further, the pipeline analyzer system will extract information from the first node of the station line, such as station, three-dimensional coordinate location and segment type (segment or arc), and write it to a segment list or array. The system will step through each node of the station line, extract the information, and write it to the segment array. When the station line is finished, the pipeline analyzer system can examine the profile line in the same manner, extract the information, and write it to the same segment array. The segment array, containing node information from both lines, will be ordered by station, thus putting the information in order from first station to last, independent of whether the node belongs to the station or profile line. The system will loop through the segment array and draw a three-dimensional, cleaned, multi-segmented line using the segment type information from the array.

Next, the pipeline analyzer system can prepare tension information from the calculated data. The system can also receive input including the following information from an outside data source, user input, hard coded information, or automatically generated by the pipeline analyzer system and assign it to corresponding variables:

Tᵢₙ=tension into a section (pounds)

Tₒᵤₜ=tension out of a section (pounds)

w=weight correction factor

μ=coefficient of friction

W=weight of cable assembly (pounds/foot)

L=length of straight section (feet)

θ=angle of straight section from horizontal (radians)

φ=angle of bend (radians)

R=radius of bend (feet)

e=natural log base 2.7182818 . . . .

The system can examine the first segment of the cleaned, multi-segmented three-dimensional line and determine the type of segment. Based on this determination, the system can read or calculate information about the segment such as length, angle from horizontal, arc angle, and\or arc radius. The pipeline analyzer system can determine which of the following categories the segment falls in and apply the appropriate pulling tension equation to it. The pipeline analyzer system stores the result for the segment in a variable as incoming tension for the next segment. The pipeline analyzer system can step through each segment of the three-dimensional cleaned line, make a determination, apply the appropriate formula, and add the new incoming tension variable until it reaches the last segment in the line.

The categories and respective formulas are listed below.

If the segment is a line and is horizontal, the following formula will be used to calculate tension out:

Tₒᵤₜ=wμWL+Tᵢₙ

If the segment is a line and is inclined, the following formula will be used to calculate tension out when pulling up:

Tₒᵤₜ=WL(sin θ+wμ cos θ)+Tᵢₙ

If the segment is a line and is inclined, the following formula will be used to calculate tension out when pulling down:

Tₒᵤₜ=−WL(sin θ+wμ cos θ)+Tᵢₙ

If the segment is an arc and is horizontal, the following formula will be used to calculate tension out:

Tₒᵤₜ=Tᵢₙ(cos hwμφ)+(sin hwμφ)\sqrt{Tᵢₙ²+(WR)²}

If the segment is a concave up arc, the following formula will be used to calculate tension out when pulling up through the arc:

$${T}_{out} = {T}_{in} {e}^{w μφ} - \frac{WR}{1 + {( w μ )}^{2}} [ 2 w μ sin φ - ( 1 - {( w μ )}^{2} ) ( {e}^{w μφ} - cos φ ) ]$$

If the segment is a concave up arc, the following formula will be used to calculate tension out when pulling down through the arc:

$${T}_{out} = {T}_{in} {e}^{w μφ} - \frac{WR}{1 + {( w μ )}^{2}} [ \begin{matrix}2 w μ {e}^{w μφ} sin φ + \\ ( 1 - {( w μ )}^{2} ) ( 1 - {e}^{w μφ} cos φ )\end{matrix} ]$$

If the segment is a concave down arc, the following formula will be used to calculate tension out when pulling up through the arc:

$${T}_{out} = {T}_{in} {e}^{w μφ} + \frac{WR}{1 + {( w μ )}^{2}} [ \begin{matrix}2 w μ {e}^{w μφ} sin φ + \\ ( 1 - {( w μ )}^{2} ) ( 1 - {e}^{w μφ} cos φ )\end{matrix} ]$$

If the segment is a concave down arc, the following formula will be used to calculate tension out when pulling down through the arc:

$${T}_{out} = {T}_{in} {e}^{w μφ} + \frac{WR}{1 + {( w μ )}^{2}} [ 2 w μ sin φ - ( 1 - {( w μ )}^{2} ) ( {e}^{w μφ} - cos φ ) ]$$

The pipeline analyzer system can determine maximum tension:

T_{c}=tension on each conductor (pounds)

S=allowable stress (pounds/cmil)

A=area of each conductor (cmil)

N=number of conductors

T_{cable}=maximum allowable tension in the cable (pounds)

The pipeline analyzer system stores or can determine via input data, the number of conductors in the cable and apply the appropriate formula as follows:

If the cable is a single conductor:

T_{c}=SA

If the cable has three or fewer conductors:

Tₒᵤₜ=NT_{c}

If the cable has more than three conductors:

T_{cable}=(0.8)NT_{c}

The pipeline analyzer system can determine sidewall pressure using data generated by the pipeline analyzer system and from input data are used. The system calculates using the following:

T=tension out of bend (pounds)

R=radius of bend (feet)

w=weight correction factor

SP=sidewall pressure (pounds/foot)

The pipeline analyzer system can also determine the number of conductors in the cable and apply the appropriate formula as follows:

If the cable is a single conductor:

$$SP = \frac{T}{R}$$

If the cable has three conductors that are cradled:

$$SP = ( 3 w - 2 ) \frac{T}{3 R}$$

If the cable has three conductors that are triangular:

$$SP = w \frac{T}{2 R}$$

The system can further calculate clearance and jamming ratio using formulas. The pipeline analyzer system can calculate clearance by taking the distance between the uppermost cable and the top inside of pipe and compare it to industry accepted standards and procedures. These standards and procedures can be received as input, from an outside source or generated by the pipeline analyzer system. The system can also calculate a jamming factor by dividing the pipeline inner diameter by the cable outside diameter.

With reference to FIG. 9, the pipeline analyzer system can import a graphic version of an engineering title block and insert it into the CADD or GIS software package. It can create or cut a viewing area (viewport) in the title block to view the three-dimensional or two-dimensional centerline of pipe in plan view and the profile line with grid in a profile view. In FIG. 9, the pipeline analyzer system scales the plan and profile lines 900 and 905 in such a way as to create an evenly scaled engineering drawing when plotted from the CADD package. The pipeline analyzer system will divide the width of the viewport by the length of the line and round the result to the nearest 10 or 100 to obtain an industry accepted engineering scale. The pipeline analyzer system will insert as many additional title blocks as necessary to display any additional information generated from the pipeline analyzer system such as line geometry and calculations.

FIG. 10 is a block diagram illustrating a system 10, according to an exemplary embodiment of the present invention, for analyzing a pipeline and creating pipeline data. The system 10 includes an analyzer mechanism 14 that includes internal collection instruments 16 that measures a pipeline and produces physical characteristics 19, which in one embodiment of the present invention comprises specific characteristics of each of the pipeline. For example, the physical characteristics 19 may be actual size of a pipeline. The physical characteristic data can reside on a storage 20 of analyzer mechanism 14.

A computer 28 compiles the transmitter data 24 to generate views and reports 24. The display 26 outputs the compiled views and reports 24 from the computer 28.

The system 10 also includes computer readable medium 32 having programming instructions 12 to control the processor to receive the transmitted data 24 from the analyzer mechanism 14. The analyzer mechanism 14, in one embodiment, is a pipeline measuring probe specially designed for measuring pipelines. Computer readable medium 32 also includes programming instructions for determining pipeline data 18. The programming instructions include instructions for performing the functions described hereinabove. For example, the steps of FIGS. 2 and 3. The programming instructions for determining pipeline data 18 can use the transmitted data via an input into 28 to perform calculations which can then be used to determine bending ratio and tension in a pipeline for delivering or installing a product there through.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements. For example, it is to be understood that the present invention contemplates that, to the extent possible, one or more features of any embodiment can be combined with one or more features of any other embodiment.

What is claimed is:

1. A system for analyzing a pipeline, comprising:
at least one analyzer mechanism configured to measure at least one physical characteristic associated with the pipeline and transmit data based upon the at least one measured physical characteristic; and
at least one computer having a computer readable medium having stored thereon instructions, which, when executed by a processor of the computer, causes the processor to implement the instructions, wherein the at least one computer is in communication with an input mechanism and a display unit, the at least one computer comprising programming instructions adapted to operate the processor to receive the transmitted data; and programming instructions adapted to operate the processor to determine pipeline data associated with the pipeline.

2. The system as defined in claim 1, wherein the at least one computer further comprises programming instructions adapted to operate the processor to determine, based at least in part upon the received data, at least one of the following: bending radius data, pulling tension data, sidewall pressure data, or any combination thereof.

3. The system as defined in claim 1, wherein the at least one analyzer mechanism is a probe including:
internal data collection instrumentation configured to measure the at least one physical characteristic; and
a storage device configured to store collected data.

4. The system as defined in claim 1, wherein the at least one physical characteristic includes at least one of the following: distance traveled, depth, elevation, angle, change in inclination, change in speed, or any combination thereof.

5. The system as defined in claim 1, wherein the at least one analyzer mechanism further comprises a communications interface to transmit the data to the at least one computer.

6. The system as defined in claim 1, wherein the at least one computer further comprises programming instructions adapted to operate the processor to convert the data received from the at least one analyzer mechanism into a readable format.

7. The system as defined in claim 1, wherein the received data comprises physical characteristic data in three dimensions at least one specified point along the pipeline.

8. The system as defined in claim 1, wherein the at least one computer further comprises programming instructions adapted to operate the processor to generate a three-dimensional array of X-Y-Z data representative of physical characteristics of the pipeline, wherein the three-dimensional array is parsed into individual three-dimensional points comprising x, y, and z numeric values.

9. The system as defined in claim 8, wherein the at least one computer further comprises programming instructions adapted to operate the processor to condense the three-dimensional array into a condensed three-dimensional array comprising a point array including specified points from the three-dimensional array, until the point array is of a specified size for processing.

10. The system as defined in claim 8, wherein the at least one computer further comprises programming instructions adapted to operate the processor to: (i) determine a straight three-dimensional line drawn from a starting point to an ending point; (ii) loop through the three-dimensional array, extracting three-dimensional coordinates; and (iii) insert the extracted three-dimensional coordinates as nodes into the straight three-dimensional line until all the three-dimensional coordinates have been inserted, thereby forming a segmented three-dimensional line representing a pipeline centerline.

11. The system as defined in claim 8, wherein the at least one computer further comprises programming instructions adapted to operate the processor to at least one of: (i) analyze the three-dimensional array and indicate station marks along a straight three-dimensional line; (ii) analyze the three-dimensional array and visually indicate a profile view of the pipeline on the display unit; (iii) convert the profile view into segments and arcs; (iv) combine station marks and the profile view into one three-dimensional line; (v) calculate pulling tension data; (vi) calculate sidewall pressure; (vi) create at least one engineering drawing, or any combination thereof.

12. The system as defined in claim 8, wherein the at least one computer further comprises programming instructions to operate the processor to calculate pulling tension data by:
examining a first segment of a segmented three-dimensional line;
determining a type of segment;
determining, based on the type of segment, a category of segment;
applying a pulling tension equation;
storing the result of the application for the segment in a variable;
utilizing the variable as tension in connection with a subsequent segment; and
repeating for each segment of the segmented three-dimensional line.

13. The system as defined in claim 12, wherein segment categories include at least one of the following: a horizontal line, an inclined line, a horizontal arc, a concave up arc, a concave down arc, or any combination thereof.

14. A computer-implemented method on at least one computer having a computer readable medium having stored thereon instructions, which when executed by a processor of the computer, causes the processor to implement the method, comprising:
receiving data transmitted from at least one analyzer mechanism configured to measure at least one physical characteristic associated with a pipeline; and
determining pipeline data associated with the pipeline.

15. The computer-implemented method defined in claim 14, further comprising programming instructions adapted to operate the processor to determine, based at least in part upon the received data, at least one of the following: bending radius data, pulling tension data, sidewall pressure data, or any combination thereof.

16. The computer-implemented method as defined in claim 14, wherein the at least one physical characteristic includes at least one of the following: distance traveled, depth, elevation, angle, change in inclination, change in speed, or any combination thereof.

17. The computer-implemented method as defined in claim 14, further comprising at least one interface to receive the data transmitted from the at least one analyzer mechanism in at least one of the following forms: wirelessly, hard-wired, via a portable memory device, or any combination thereof.

18. The computer-implemented method as defined in claim 14, further comprising programming instructions adapted to operate the processor to generate a three-dimensional array of X-Y-Z data representative of physical characteristics of the pipeline, wherein the three-dimensional array is parsed into individual three-dimensional points comprising x, y, and z numeric values.

19. The computer-implemented method as defined in claim 18, further comprising programming instructions adapted to operate the processor to condense the three-dimensional array into a condensed three-dimensional array comprising a point array including specified points from the three-dimensional array, until the point array is of a specified size for processing.

20. The system as defined in claim 18, further comprising programming instructions adapted to operate the processor to: (i) determine a straight three-dimensional line drawn from a starting point to an ending point; (ii) loop through the three-dimensional array, extracting three-dimensional coordinates; and (iii) insert the extracted three-dimensional coordinates as nodes into the straight three-dimensional line until all the three-dimensional coordinates have been inserted, thereby forming a segmented three-dimensional line representing a pipeline centerline.

21. The computer-implemented method as defined in claim 18, further comprising programming instructions adapted to operate the processor to at least one of: (i) analyze the three-dimensional array and indicate station marks along a straight three-dimensional line; (ii) analyze the three-dimensional array and indicate a profile view of the pipeline; (iii) convert the profile view into segments and arcs; (iv) combine station marks and the profile view into one three-dimensional line; (v) calculate pulling tension data; (vi) calculate sidewall pressure; (vi) create at least one engineering drawing, or any combination thereof.

21. The computer-implemented method as defined in claim 18, further comprising programming instructions to operate the processor to calculate pulling tension data by:
examining a first segment of a segmented three-dimensional line;
determining a type of segment;
determining, based on the type of segment, a category of segment;
applying a pulling tension equation;
storing the result of the application for the segment in a variable;
utilizing the variable as tension in connection with a subsequent segment; and
repeating for each segment of the segmented three-dimensional line.

22. An article comprising a machine-readable storage medium containing instructions that, if executed, enable a processor to:
receive data transmitted from at least one analyzer mechanism configured to measure at least one physical characteristic associated with a pipeline; and
determine pipeline data associated with the pipeline.

23. A pipeline analyzing software stored on a storage medium to analyze a pipeline, the software comprising programming instructions that, if executed, enable a processor to:
receive data transmitted from at least one analyzer mechanism configured to measure at least one physical characteristic associated with a pipeline; and
determine pipeline data associated with the pipeline.

24. A method for determining pipeline data for installing a product in a pipeline, comprising:
measuring, by at least one analyzer mechanism, at least one physical characteristic of a pipeline, thereby creating measurement data;
transmitting, from the at least one analyzer mechanism, at least a portion of the measurement data; and
receiving the transmitted measurement data on at least one computer and determining at least one of pulling tension data and bending radius data, based at least in part on the received measurement data.

25. The method of claim 24, wherein the step of measuring further comprises:
placing at least one probe into the pipeline;
moving the probe through the pipeline;
measuring the at least one physical characteristic using internal data collection instrumentation of the probe; and
storing the measured at least one physical characteristic on a storage device of the probe.
